(19) United States
(12) Patent Application Publication
(10) Pub. No.: US 2010/0087249 A1
(43) Pub. Date: Apr. 8, 2010

(54) Ancillary display component for a gaming machine

(75) Inventor: Richard E. Rowe, Las Vegas, NV (US)

Correspondence Address: Weaver Austin Villeneuve & Sampson LLP - IGT;Attn: IGT, P.O. Box 70250, Oakland, CA, 94612-0250, US

(73) Assignee: IGT

(21) Appl. No.: 12/287,224

(22) Filed: Oct. 6, 2008

(51) Int. Cl. A63F 13/00; A63F 9/24

(52) U.S. Cl. 463/31; 463/30; 463/16

(57) ABSTRACT

The present invention discloses gaming machines with ancillary display monitors that operate independently of the gaming machine and methods of using the monitors to interact and engage with players. A gaming machine may have one or more monitor components that are physically attached to the gaming machine and can be adjustable to accommodate player ergonomics. In one embodiment, there are no data connections between a monitor component and the gaming machine. The monitors obtain data from non-gaming or secondary gaming data networks rather than a primary gaming network (e.g., a server-based gaming network) that the gaming machine may be connected to for wager game play. The display components may have RFID capabilities that allow them to interact with a player and which enable the player to obtain a wealth of non-gaming data and secondary gaming information, such as information on tournaments, progressive slots, and so on that is not directly related or dependent on the primary game play. Processors in the ancillary display components are not subject to gaming regulations of the local jurisdiction since they do not affect game play on the machine and they do not communicate with the master gaming controller of the gaming machine. The only non-mechanical connection with the gaming machine may be an A/C power connection if the machine has an external outlet and provides electrical power to the display monitor component.

### BACKGROUND OF THE INVENTION

1. Field of the Invention

The present invention relates to wager gaming machines. More specifically, it relates to gaming machine displays and non-gaming functionality.

2. Description of the Related Art

In the casino environment, the gaming machine has become what may be referred to as a touch point. It has become the component on the casino floor with which players are most familiar, spend the most time, and are most comfortable handling. Players often situate themselves with a machine and play on that same machine for hours. The amount of time spent with other components on a casino floor, such as information kiosks, ticket redemption machines, various non-gaming terminals, and the like, is relatively insignificant compared to the time spent in front of gaming machines.

Presently some gaming machines offer a variety of non-gaming information either on the main display of the machine or on a secondary display, both of which are housed within the cabinet (or chassis) of the machine. This non-game play data, such as promotions for other casino services, advertising, new game promotion, player-tailored hospitality data, among many other types of data, is typically transmitted to the gaming machine via the primary gaming network. That is, it is “piped in” through the same network that is used for communicating game play data. As a result, demands on the gaming network are increasing, as more bandwidth is being used for non-game play activities. Moreover, valuable screen space on the main gaming machine monitor is being used for communicating data unrelated to game play and wagering.

This prime screen “real estate” is often used to display non-game play data and, in many cases, may decrease the amount of space on the screen used for game play (e.g., windows may be re-sized and shifted, symbols and letters may be reduced or scaled down accordingly, etc.) and, more importantly, may interrupt actual game play. For many players who get into a certain rhythm and are comfortable with the speed with which they are playing games (dealing cards, placing bets, etc.), this type of interruption can be distracting and may discourage game play. Casinos generally prefer that patrons wager on games of chance over interrupting them and minimizing such game play for the opportunity to present non-gaming data, such as, promotions and marketing content. They would also prefer to use other networks to transmit or pipe in this data rather than using the primary gaming network.

### SUMMARY OF THE DESCRIBED EMBODIMENTS

The present invention discloses gaming machines having ancillary display monitors that operate independently of the gaming machine and methods of using the monitors to interact with players. A gaming machine may have one or more monitor components that are physically attached to the gaming machine and can be adjustable to accommodate player ergonomics. In one embodiment, there are no data connections between a monitor component and the gaming machine. The monitors obtain data from non-gaming or secondary gaming data networks rather than a primary gaming network (e.g., a server-based gaming network) that the gaming machine may be connected to for wager game play. The display components may have RFID capabilities that allow them to interact with a player (or a companion) and which enable the player to obtain a wealth of non-gaming data, related to hospitality, shows, casino and hotel services, room information, and the like. The player may also be presented with a variety of secondary gaming information, such as information on tournaments, progressive slots, and so on that is not directly related or dependent on the primary game play, which is handled by the gaming machine. As such the processors in the ancillary display components are not subject to gaming regulations of the local jurisdiction since they do not affect game play on the machine and they do not communicate with the master gaming controller of the gaming machine. The only non-mechanical connection with the gaming machine may be an A/C power connection if the machine has an external outlet and provides electrical power to the display monitor component.

In one embodiment, a gaming machine has a cabinet, a master gaming controller configured to provide games of chance, and a primary video display mounted to the cabinet that is coupled to display game play data resulting from game play that is subject to gaming regulations of the local jurisdiction. Also attached to the gaming machine is an ancillary display component (which may also be referred to as a video display) having a monitor and a logic processor. The ancillary display component may be mechanically attached to the cabinet and may be moveable with respect to the cabinet to accommodate player ergonomics. The ancillary display component displays non-gaming data and/or secondary gaming data during game play on the primary video display in a manner such that game play on the primary video display is uninterrupted. The display component may also receive non-gaming data and secondary gaming data asynchronously with respect to the master gaming controller of the gaming machine receiving and transmitting game play data. The display component operates independently of the operational state of the gaming machine. For example, if the gaming machine is in a tilt state, the ancillary display components may continue operating and receiving data from their respective networks.

In another embodiment, a gaming system has a gaming machine, a first host server, and a second host server. The gaming machine has a cabinet, a master gaming controller configured to provide wager games, a primary game play monitor, a gaming machine network interface and an ancillary monitor component mechanically attached to the cabinet having an ancillary network interface and logic component. The first host server may be a host server in a gaming network and is coupled to display on the primary game play monitor, game play data to the master gaming controller, the game play data transmitted over a primary gaming network utilizing the gaming machine network interface. The second host server may be coupled to provide, for display on the ancillary monitor component, non-game play data and secondary gaming data, to the ancillary monitor component, the data being transmitted over a non-gaming network utilizing the ancillary network interface. In one embodiment, the non-game play/secondary gaming data and the game play data are transmitted asynchronously via the secondary network and the first network respectively, thereby enabling viewing of the non-game play/secondary gaming data on the ancillary monitor component without interruption of game play on the primary game play monitor.

Another embodiment is a method of operating a gaming machine when used by a player. A player may be detected using an RFID reader in an ancillary display component mechanically attached to a gaming machine cabinet. The player may be identified using RFID data received from the player and non-gaming and secondary gaming data associated with the player may be obtained from non-gaming servers. Non-gaming and secondary gaming data are displayed to the player and the player is engaged and interacted with by providing services to the player using the ancillary display component. The position of the ancillary display component may be adjustable and operates independently of the gaming machine. In one embodiment, the ancillary display component does not interact with a master gaming controller of the gaming machine and is outside the purview of gaming regulators.

### BRIEF DESCRIPTION OF THE DRAWINGS

References are made to the accompanying drawings, which form a part of the description and in which are shown, by way of illustration, particular embodiments:

FIGS. 1A to 1D are perspective illustrations of a gaming machine having two ancillary video display modules in accordance with one embodiment;

FIG. 2 is a detailed view of an ancillary video display module attached to a gaming machine as seen by a player positioned in front of the machine in accordance with one embodiment;

FIG. 3 is a network diagram showing a gaming machine with ancillary video display modules and various connections to gaming and non-gaming servers;

FIG. 4 is a block diagram showing various components of an ancillary video display module in accordance with one embodiment of the present invention; and

FIG. 5 is a flow diagram of a process of interacting with a player having an RFID tag by a gaming machine equipped with an ancillary video display module of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order to not unnecessarily obscure the present invention.

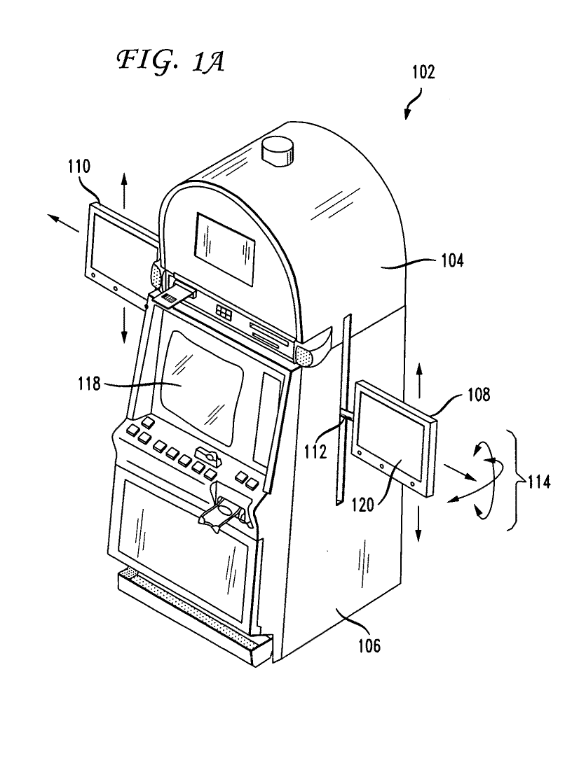

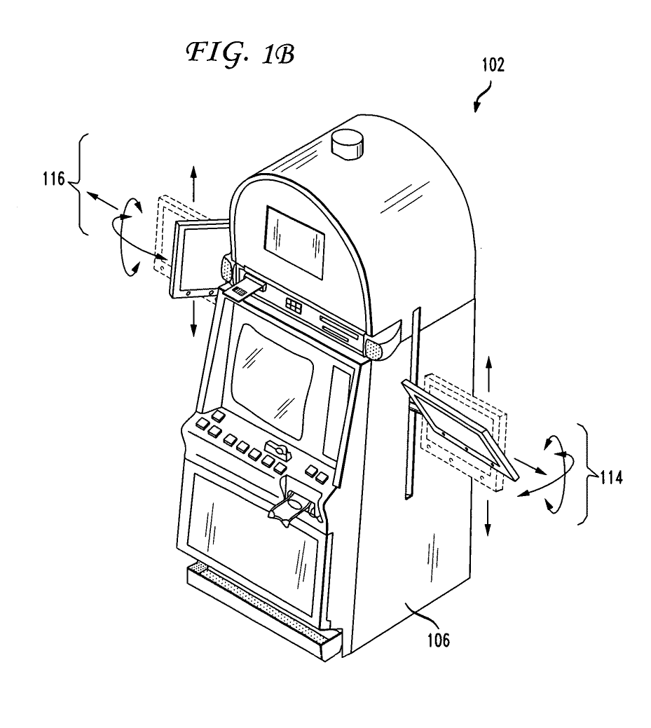

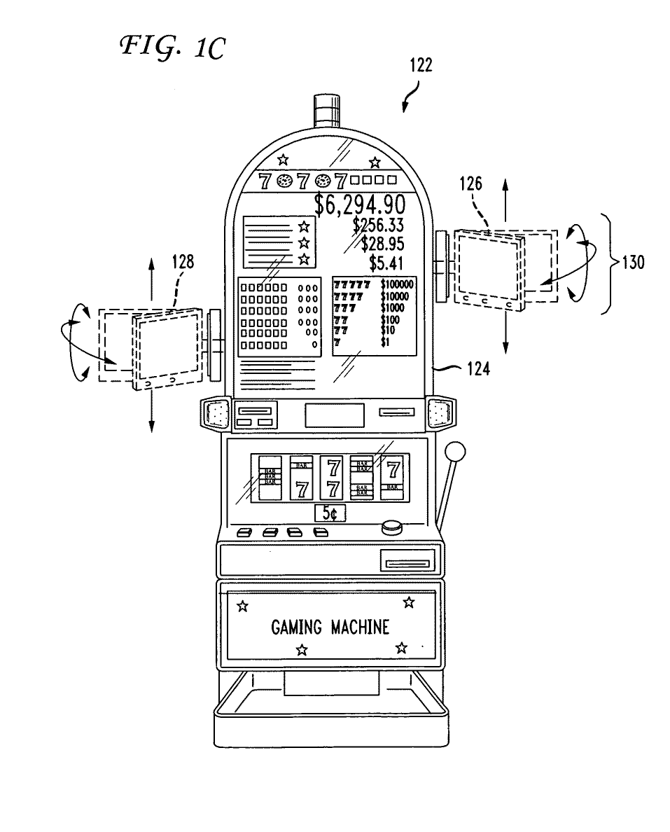

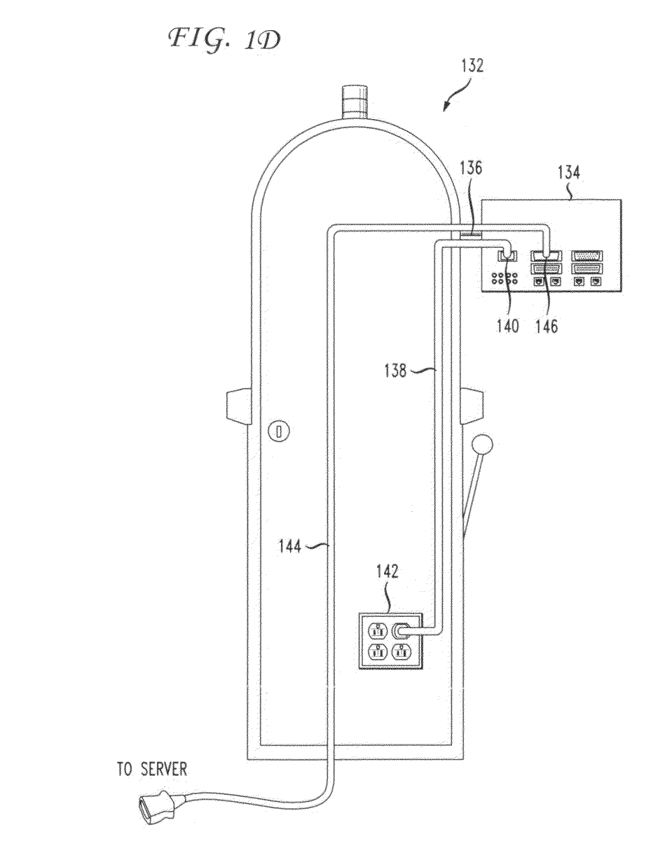

Ancillary video display modules on a gaming machine and methods of displaying data on the modules enabling interaction with a player using the module are described in the various figures. The video display module expands the functionality of a gaming machine to include aspects of the gaming machine's location and interaction with the player. FIGS. 1A to 1D are perspective illustrations of a gaming machine having two ancillary video display modules in accordance with one embodiment. A gaming machine 102 has a cabinet or chassis 104 which has two sides, side panel 106 (shown) and another side panel (not shown) in FIG. 1A.

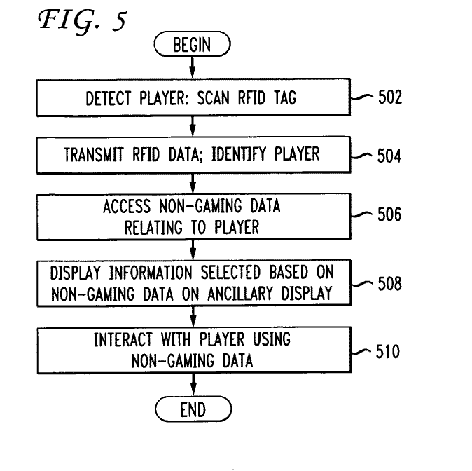

Two ancillary video display modules 108 and 110 are mechanically attached to gaming machine 102 using a suitable attachment means 112. Such means may include a hinge and slide-out extension bracket. In one embodiment, a vertically sliding side mounting rod has one end attached to gaming machine and another attached to module 108 using a conventional bracket or hinge. The mounting rod may be extendable so that the length can be adjusted by sliding it out sideways. In one embodiment, the position of a display module may be adjusted in numerous ways. As shown by directional arrows 114, display may be adjusted so that it may be viewed at various angles. For example, as shown in FIG. 1B, the face of the display module may be tilted up and down, inward towards the gaming machine, and outward from the machine as shown by arrows 116. The length between a display module and gaming machine may be adjusted to be close to the gaming machine (e.g., abutting the machine) or be further extended from the machine so that, for example, another person at the machine may view it while not be sitting too close to the gaming machine player. In one embodiment, a display module may be held in position by a latch mechanism (not shown) such a spring-loaded pin. Such means may depend on properties of the cabinet, such as shape and materials (e.g., plastic, metal, etc.). It may also depend on the machine's orientation and placement in relation to other machines, such as space between machines. Further details on physical attributes and internal components of modules 108 and 110 are provided in FIG. 5. Gaming machine 102 also has a primary display 118 and may have secondary display area housed within cabinet 104.

One of the primary components of display module 108 and 110 is a monitor or screen 120. In one embodiment, the screen may be a high-resolution flat panel LCD, a cathode ray tube, projection-type LCD, plasma display, field emission display, a digital micromirror device (DMD), organic LCD or other conventional electronically controlled video monitor. In another embodiment, the monitor may be a multilayer display or a multi-touch display. Multilayer displays are described in application Ser. No. 11/938,151, titled “Presentation of Wheels on Gaming Machines Having Multi-Layer Displays,” filed on Nov. 9, 2007, which is incorporated by reference herein in its entirety and for all purposes.

FIG. 1C is a frontal view of a gaming machine 122 having a different housing 124 with two ancillary video display modules 126 and 128 at different levels or heights. A player sitting in front of machine 122 is able to adjust display modules 126 and 128 to numerous angles and heights as shown by arrows 130. A display module may be fully folded in or stowed in position where it is hidden from view as shown by arrows 128 and 130 and 116 in FIG. 1B or extended fully out as by arrows 114 in FIG. 1A.

FIG. 1D is a rear view of a gaming machine 132 and of an ancillary video display module 134 in accordance with one embodiment. As described above, ancillary module 134 is attached to gaming machine via a suitable mechanical means 136. In the embodiment shown, ancillary video display module 134 receives electrical power from machine 132 via A/C cord 138 extending from display module A/C input 140 to an outlet 142 provided by machine 132 which has a power distribution box. In other embodiments display module 134 draws electrical power from a wall outlet, another nearby gaming machine that has electrical outlets, or other suitable power source in the gaming environment. In other embodiments, the display may be battery operated. Also shown is a wired connection 144 from a serial port 146 in module 134 to a non-gaming server (not shown).

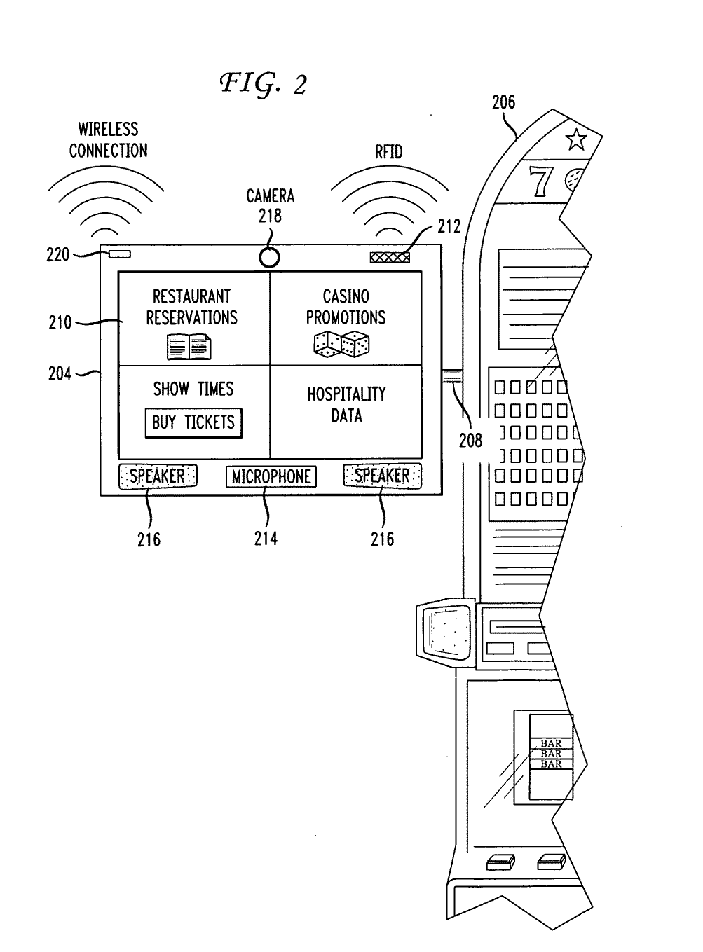

FIG. 2 is a detailed view of an ancillary video display module attached to a gaming machine as seen by a player positioned in front of the machine in accordance with one embodiment. A display module 204 is mechanically attached to gaming machine 206 via a mounting rod 208. In one embodiment, module 204 has a screen or monitor 210, an RFID antenna 212, attached to an RFID reader (not shown), a microphone 214, speakers 216, and camera 218. In one embodiment there may also be a wireless network interface 220. Screen 210 may be logically partitioned by a graphics controller into two or more separate display areas or windows for displaying various types of information. FIG. 2 shows four sample windows. The display of data (and operations relating to the display such as closing windows, altering the configuration of the data, etc.) does not affect, nor is it affected by, the display of game play data on the gaming machine 206 primary display.

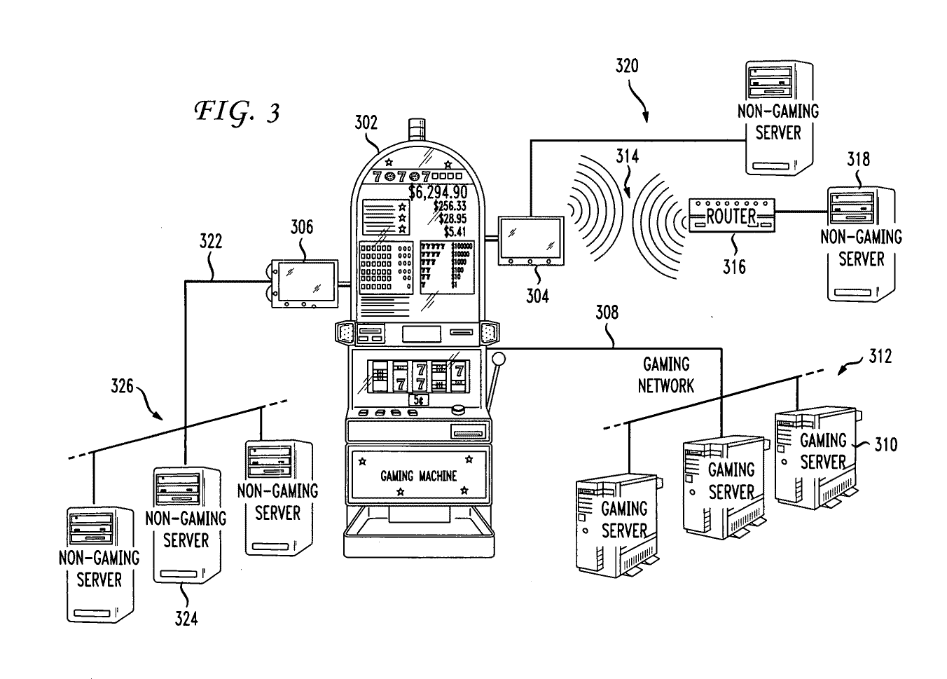

Wireless network interface 220 may be used by ancillary video module 204 to communicate with servers in the casino using wireless networking protocols. In another embodiment, interface 220 may be used to connect with hand-held player devices, such as MP3 players, mobile handsets, gaming devices, cell phones, laptop computers, tablets, and the like. In one embodiment these servers are not part of the casino gaming network to which the gaming machine is connected. However, as described in FIG. 3 below, these non-gaming servers may be connected to each other and to gaming network servers in order to share data, but, in one embodiment, are not in the same network.

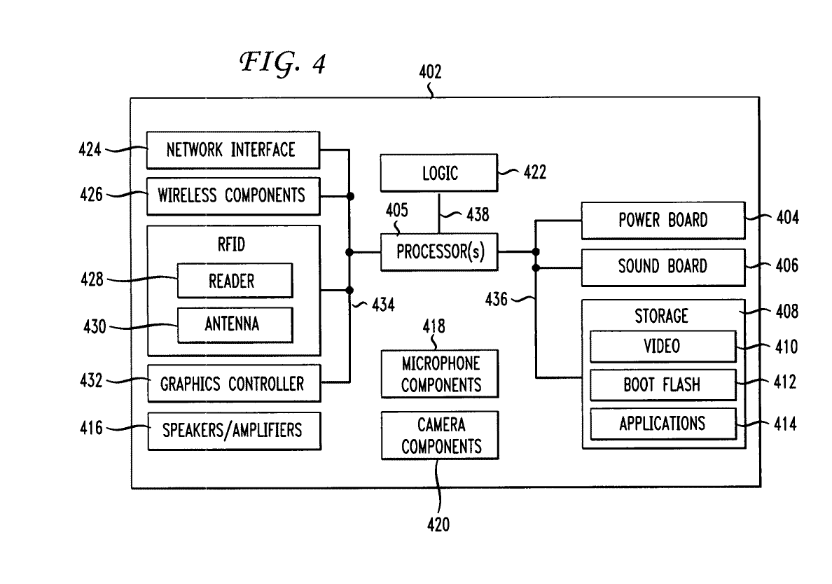

RFID antenna 212 may be used to receive data from RFID tags worn or carried by players (not shown) and used to identify such players (e.g., the tags may be issued to them by the casino or gaming operator). This allows identification of a player without the player having to insert a player tracking number or card into the machine. Any suitable commercially available RFID antenna and reader may be used. RFID antenna 212 may be encased with module 204 and not visible to the user. Processes and components relating to RFID tags and data are described in more detail in FIGS. 4 and 5.

Ancillary video module 204 may include microphone 214 for activating services and features using, for example, voice recognition. It may also be used more generally by a player to speak with a casino employee, third-party, or another patron in the casino. Speakers 216 may be used for providing audio to the player that is separate from audio provided by gaming machine 206 during game play. Ancillary display module 204 may also be equipped with one or more headsets (not shown) to allow a player (and a companion) to listen to audio from ancillary display module without interference from sounds emanating from the casino environment or gaming machine 206.

Ancillary video display module 204 may receive and transmit data via a wired network connection shown in FIG. 1D, as serial connection 144 to connect display module 204 with a non-gaming server (not shown) in the casino that is not part of the primary gaming network which, in contrast, is made up of gaming servers and servers needed for implementing game play in a network. In other embodiments, there may be more than one wired connection to non-gaming servers. There may also be wireless connections to other gaming machines (e.g., in a peer network). Display module 204 may also receive and transmit data via wireless connections via wireless network interface component 220.

FIG. 3 is a network diagram showing a gaming machine with ancillary video display modules and various connections to gaming servers, which herein refers to servers in a gaming network that may be needed for or may facilitate game playing services (i.e., game play activities that are generally regulated by gaming regulators). Also shown are connections to non-gaming servers, which generally refers to servers that provide non-gaming data and secondary gaming data, generally, data that does not fall under the purview of gaming regulators. A gaming machine 302 has an ancillary display module 304, display module 306, and a connection 308 to a gaming server 310 in a gaming network 312. Network 312 may be a server-based gaming network, a peer gaming network, or a conventional non-server based gaming network. Other gaming network components, such as DCUs, routers, gateways, and the like (not shown) may operate between machine 302 and gaming server 310.

Generally, there are several different types of servers related to various embodiments of the present invention. As noted above, a gaming network which provides wager game play functionality has various types of host gaming servers that are not directly related to the present invention (licensing servers, player tracking server, etc.). The other types of servers may be referred to generally as non-gaming host servers which include servers that provide information that are not related to gaming and servers that provide secondary gaming data (e.g., tournament data, player tracking data, data on other types of games, etc.) which relate to gaming but do not have a role in actual game play. The term “host server” may refer generically to a representative server in either type of network (i.e., gaming network, non-gaming network, server-based gaming network, etc.). In one embodiment, gaming servers in a gaming network may store non-gaming data and secondary gaming data, and such servers may provide data to ancillary display module 304. In another embodiment, gaming servers in gaming network may share data with non-gaming servers, however any data and functionality relating to actual game play will not be shared in accordance with gaming regulations.

A host server whether in a gaming network (a host gaming server) or in a non-gaming network (a host non-gaming server), may be implemented in various ways. For example, a host server may be comprised of multiple separate computers, some or all of which having their own processor and hardware platform. In another embodiment, a host server may be implemented within a single hardware platform configured with multiple application server software programs implementing various gaming or non-gaming functions. In another embodiment a host server may be implemented as a single hardware platform with multiple blade servers, where some or all of the blade servers within the single hardware unit may function as a host server.

Returning to FIG. 3, ancillary display module 304 has a wireless connection 314 to a wireless router 316 connected to a non-gaming server 318 which is part of a non-gaming network 320. Similarly, ancillary display 306 has a wired connection 322 to a non-gaming server 324 of non-gaming network 326. In one embodiment, non-gaming networks 320 and 326 may be the same network or they may be parallel non-gaming networks (ancillary to primary gaming network 312). Networks 320, 326, and 312 may be asynchronous and independent of each other. If one network is disabled or goes down, the others may keep operating. In other embodiments there may be multiple connections from an ancillary display module to various parallel non-gaming networks or have connections to other conventional sources of non-gaming data, such as cable TV, DVD players, MP3 players, and the like. In another embodiment, a non-gaming server, for example, a casino hospitality server, may be connected to host servers 310 in gaming network 312 in order to share data. In other embodiments, gaming machine 302 may have only one ancillary display module or have more than two. In another embodiment, an ancillary display module may be connected to gaming network 312 only or to both a non-gaming network (320 or 326) and gaming network 312.

In these various embodiments, gaming machine 302 is a touch point for parallel non-gaming networks that are ancillary to the primary gaming network. Numerous data pipes may lead to gaming machine 302, instead of only one pipe used for gaming network 312. By using non-gaming networks 320 and 326, a variety of kiosks are effectively tied to gaming machine 302. In this manner, game play is uninterrupted and non-gaming data and secondary game play data may be displayed in an area larger than a conventional “service” window on the main display of the gaming machine. In another embodiment, ancillary display module 304 and 306 may not be connected to a gaming machine but may be accessible in areas of a casino or hotel (venue) where players spend time for gaming, such as a keno lounge or bingo parlor.

In one embodiment, primary game play data (such as information on various stages of game play) is not displayed on ancillary video display modules 304 or 306. This includes data relating to (1) a “currency in” stage in which the machine awaits a coin or bill insertion to initiate a play, (2) a “game play” stage in which the player has initiated play, and (3) a “game result” stage in which a payout or no-payout event is registered. Other primary gaming events may include general gaming machine state changes such as malfunction (e.g., a tilt). If there is a malfunction or tilt in gaming machine 302, ancillary display module 304 and 306 may continue operating. Thus, ancillary display module 304 and 306 can operate without gaming control board or other regulatory body approval and are independent of gaming machine 302 and of the machine's CPU or master gaming controller. The modules in no way effect the operations of the MGC.

Information displayed on modules 304 and 306 may include a wide range of non-gaming data and secondary game information. This type of data may include information about casino slot tournaments, progressive games, bonusing schemes, and other incentives for maintaining a player's interest or to motivate play in a particular manner. More generally, secondary game data may be any gaming and game play data that is not directly associated with or dependent on a game being played at the moment on the gaming machine 302.

Non-gaming data may include features and services, billboard information, advertisements, television programming, player attraction material, video conferencing, among others. Other types of data may include menus for casino services, such as assistance from an attendant, ordering drinks and food, reserving cabs, purchasing or reserving tickets for shows, conducting banking transactions, getting information on health clubs, shops, restaurants, etc. Non-gaming data may include hotel room data, purchases made within the venue or hotel/casino, information on shows, restaurants, and the like. In one embodiment, television programming may be provided to ancillary display module via a cable link or other suitable link. All or a subset of the programming provided by a television broadcaster may be displayed. Broadcasts of competitive events on which the player can wager may be displayed, such as horse racing events. In such events, there is typically a rather long down time between races. During this period, the player may play the gaming machine. Then, when a race begins, the player focuses his or her attention on that event without needing to leave his position at the gaming machine.

FIG. 4 is a block diagram showing various components of an ancillary video display module in accordance with one embodiment of the present invention. As described above, one or more ancillary video display modules are mechanically attached to a gaming machine and, in one embodiment, may not have any type of electronic data, video, or audio connection with the machine (other than for A/C power in one embodiment). As such, the ancillary display module may be described as a self-sufficient, stand-alone information kiosk device, logically separate from the gaming machine. In one embodiment, the module may serve as an interactive, information kiosk, replacing conventional information kiosks typically situated throughout a casino. As noted above, the ancillary video display module is an independent component and its operation does not depend on the operational state of the gaming machine, with the one exception in the case the module draws electrical power from the gaming machine in which case the machine's power supply (or power distribution center) must be able to supply power.

An ancillary display module 402 has a power board 404 which controls and regulates power supply to components in module 402. In one embodiment module 402 may operate on D/C current. Also included is a processor 405 which is dedicated to ancillary component display module and is connected to logic module 422 for overall operation of module 402 plays no role in the outcome of a game or bonusing scheme on the gaming machine. This separation of responsibilities between the master gaming controller (MGC) and processor 405 allows ancillary module 402 to operate without regulatory approval from relevant gaming authorities or gaming control boards. The MGC and game play software have already been approved by the relevant gaming authority. The introduction of processor 405 to the gaming machine system for the purpose of display non-gaming and secondary gaming data does not affect game outcomes and would not require additional scrutiny or approval with respect to wager game play.

Module 402 may also have a sound board 406 which controls various audio aspects of display 402. Display module 402 may have speaker and amplifier component 416. Other audio hardware may include microphone components 418 for detecting a player's voice. Display module 402 may also have camera component 420 for capturing still or moving images of the player or other objects.

A storage area 408 stores various types of data that may be needed by the display 402. For example, storage 408 may include video storage 410 and boot flash storage 412 for booting module 402. Also included is application storage area 414 for storing various applications such as voice recognition software, MP3 and multi-media software, browser among many other possible applications. In one embodiment, module 402 may have connectors for enabling playback of MP3 files from an external player.

Display 402 is connected to one or more networks via network interface components 424 which may include components 426 for wireless communications. Wireless components 426 may also be used for wireless communications with mobile devices used by players, such as handsets, wireless gaming devices, and tablets and the like. Well known wireless communication protocols such as 801.11x, Bluetooth, Wi-Fi, WiMax, and others may be utilized for enabling such communication.

Ancillary display module 402 may also have RFID capabilities and include an RFID reader 428 and antenna 430. An RFID tag may be worn or carried by a player and will typically include a microprocessor and antenna. In one implementation, the tag's antenna picks up a magnetic field and is powered when within the field, generated by RFID reader 428 and emanating from antenna 430. Antenna in the RFID tag may be a metal coil made of conductive metal (etched in silicon). RFID tag modulates the signal according to information encoded in the tag and transmits a modulated signal to RFID reader 428 via antenna 430.

If a gaming machine has its own RFID capabilities, RFID reader 428 and antenna 430 in ancillary display module 402 may be configured to not interfere with the RFID reader and antenna in the gaming machine using methods known in the art. For example, RFID tags may be encoded differently so that they are powered only by certain readers.

In one embodiment, RFID tags may use one of the Electronic Product Code (“EPC”) formats for encoding information and may include specific player information, in addition to a player identifier. EPC codes may be formed in various lengths (common formats are 64, 96 and 128 bits) and have various defined fields, which may allow for identification of a player, as well as other information, such as player tracking number, room number, hospitality, preference data, and the like. The RFID tags may be active tags which have their own power source or passive which do not have their own power source. They are powered as described above, that is, when the tag is interrogated by RF reader 428 at the right radio frequency. At this frequency the antenna picks up a small amount of electromagnetic energy used to power the logic device within the tag. RFID tags may be inductively coupled, capacitvely coupled, or propagation coupled tags. RFID reader 428 may be designed to program the tag with data. Further details on RFID readers and tags as used in a gaming environment are described in application Ser. No. 10/214,936, titled “FLEXIBLE LOYALTY POINTS PROGRAMS”, filed on Aug. 6, 2002, which is incorporated herein in its entirety and for all purposes.

Graphics controller 432 controls data transmitted to the monitor. It receives digital images from processor 405 and provides pixel-by-pixel digital output to the monitor. In another embodiment, graphics controller 432 also provides some higher level functionality such as resizing graphical displays and the like. By providing such high level functionality, it reduces the burden on processor 432. One suitable graphics controller is the model CL-GD 7548 available from Cirrus Logic of Fremont, Calif.

Graphics controller 432 may be coupled to video memory 410 which may temporarily store a limited number of video images for rapid display on monitor. In one example, video memory 410 stores about two megabytes of video data, implemented with four 256K by sixteen DRAM devices. More preferably, video memory 410 has the capacity to store 8-10 megabytes of images for display. Video data storage in memory 410 is preferably provided in an uncompressed format. It may store a currently displayed frame plus other video information that might be displayed in the very near future. Controller 432 generally represents controllers capable of driving plasma displays, field emission displays, digital micromirror displays, LCD flat panel, and other types of monitors.

Local buses 434, 436, and 438 enable communication of addresses, data, and control signals between the various components described above with processor 405. There may be other buses coupling components, such as buses connecting microphone component 418, camera components 420, and speakers 416 to power board 404 and sound board 406.

Ancillary video display module may be encased in a metal or plastic housing having various connector ports and memory drive inserts. In one embodiment, display module may contain flash disk drives for storing boot loading software and other data, such as animation, applications, and so on. There may be connectors for power and audio transmitted from an external source. In other embodiments, there may also be USB, FireWire, or other data connector ports, MP3 ports, biometric readers and the like.

FIG. 5 is a flow diagram of a process of interacting with a player having an RFID tag by a gaming machine equipped with an ancillary video display module of the present invention. At step 502 the RFID reader scans or reads an RFID tag of a player who has sat or positioned himself in front of the machine. A player may obtain an RFID tag as part of being in a casino loyalty program or, if the casino is associated with a hotel, when registering with the hotel. There may be other instances or scenarios where a player may obtain an RFID tag. When the casino issues a tag to a player, certain information on the player is stored on one or more back-end servers. The specific data stored on a player may vary widely. For example, a player with a player tracking card (i.e., part of a loyalty program with the casino) will likely have an existing repository of data with the casino that may be associated with the RFID tag identifier. A new player or casino guest may have only minimal information, such as hotel room, length of stay, and maybe some basic information on hospitality-related preferences provided, for example, when checking into the hotel/casino. The specific back-end host server used to store player data may depend on the status of the player.

Once the RFID tag has been scanned and an RFID tag identifier is transmitted to the reader in the ancillary video component, the identifier is transmitted to a host server in a non-gaming network and the player is identified at step 504. In one embodiment, all RFID tag data is stored in one or more RFID servers having a player database. Each RFID tag number identifies a unique player. At step 506 the host server accesses non-gaming data associated with the player. As noted above, the amount of non-gaming data available may depend on the relationship between the player and gaming operator. In some embodiments, the non-gaming related player data may be stored in the host server and in other embodiments there may be a pointer to a player tracking database that contains data relating to the player. There are various configurations that may be implemented with respect to RFID servers, “hospitality” servers that store hotel and player-preference data for new players and for players with player tracking cards. Regardless of the manner in which the non-gaming data is stored (there may be a variety of configurations), at step 504 the data is accessed using a player identifier.

At step 508, information selected or derived from the non-gaming data accessed at step 506 is displayed to the player at step 508. This information may be presented in a variety of forms and some it may not be necessarily tied or related to the player data accessed at step 506. For example, some of the data may be general casino and hotel advertisements and marketing content, which may be shown in cases where the system has only minimal data associated with the player. In other embodiments, the information displayed may not relate to the player or be derived from player data at all and may only be general marketing/informational displays or be tied to another factor. Such factors may include location of the machine, time of day, day of week, special event scheduling, and the like. As described above, this information may be displayed in many ways. In one embodiment, services that are relevant to the player are shown and offers may be made, followed by interaction, without shifting of game play data or interrupting game play.

At step 510 the ancillary video display module enables interaction between the player and the non-gaming data displayed to the player. If the information displayed requests input from the player or is presented in a manner where the player can input data at any time, the component enables such interaction. For example, a player may touch the screen to make a selection, type in text or numeric data, and the like. In other embodiments, a player may use a stylus, pen, or mouse-type input device to enter information. A player may also use voice activation and speech recognition to input information and interact with the video display module.

The information inputted by the player is transmitted to one or more back-end host servers, such as a hospitality server, which may continue the interaction by sending further information to the module based on the selections and responses by the player. In this manner, in one embodiment, the module of the gaming machine functions as a kiosk and interacts with the player using non-game play data while concurrently allowing the player to continue playing games of chance and utilize the maximum display area on the main game play screen in the gaming machine.

Although illustrative embodiments and applications of this invention are shown and described herein, many variations and modifications are possible which remain within the concept, scope, and spirit of the invention, and these variations would become clear to those of ordinary skill in the art after perusal of this application. For example, ancillary video display modules may have data connections with the casino gaming network. They may also have connections with the gaming machine for sharing gaming and non-gaming data. In another example, the video display modules may also be contained within the chassis of a gaming machine rather than being mechanically attached to the machine. In another example, the display module may simply be a video monitor without any other features or user interface components. Accordingly, the embodiments described are to be considered as illustrative and not restrictive, and the invention is not to be limited to the details given herein, but may be modified within the scope and equivalents of the appended claims.

What is claimed is:

1. A gaming machine comprising:
a cabinet;
a master gaming controller configured to provide one or more games of chance;
a primary video display mounted to the cabinet, the primary video display coupled to display game play data; and
an ancillary display component having a monitor and a logic processor, the ancillary display component mechanically attached to the cabinet, the display component being moveable with respect to the cabinet to accommodate player ergonomics;
to wherein the ancillary display component is coupled to:
display non-gaming data and secondary gaming data during game play on the primary video display, such that the game play on the primary video display is uninterrupted, and
receive non-gaming data and secondary gaming data asynchronously with respect to the master gaming controller of the gaming machine receiving and transmitting game play data; and
wherein the ancillary display component operates independently of an operational state of the gaming machine.

2. A gaming machine as recited in claim 1 wherein the ancillary display component further comprises a radio frequency identifier (RFID) reader.

3. A gaming machine as recited in claim 2 wherein the ancillary display component further comprises an RFID antenna.

4. A gamine machine as recited in claim 1 wherein the ancillary display component may be stowed in towards the gaming machine, thereby physically placing the monitor out of view of a player.

5. A gaming machine as recited in claim 1 wherein the ancillary display component is vertically mobile along a side of the gaming machine.

6. A gaming machine as recited in claim 1 wherein the ancillary display component monitor may be angled upward or downward.

7. A gaming machine as recited in claim 1 wherein the ancillary display component further comprises a network interface.

8. A gaming machine as recited in claim 1 wherein the ancillary display component further comprises a graphics controller.

9. A gaming machine as recited in claim 1 wherein the ancillary display component further comprises wireless components, a network interface, and storage.

10. A gaming machine as recited in claim 1 wherein the ancillary display component monitor further comprises one or more multi-touch displays.

11. A gaming machine as recited in claim 1 wherein the ancillary display component monitor further comprises one or more multi-layer displays.

12. A gaming machine as recited in claim 1 further comprising an electrical outlet and wherein the ancillary display component receives electrical power from the electrical outlet.

13. A gaming machine as recited in claim 1 wherein the functionality of the ancillary display component is related to a gaming machine location.

14. A gaming machine as recited in claim 1 wherein the ancillary display component is connected to one or more networks providing non-gaming data and secondary gaming data.

15. A gaming machine as recited in claim 1 wherein non-gaming data includes hospitality data, location-specific data, hotel room data, hotel show data, and player purchase data.

16. A gaming machine as recited in claim 1 wherein the logic processor of the ancillary display component controls display of non-gaming data and secondary gaming data only, thereby placing operation of the ancillary display component outside of gaming regulatory approval.

17. A gaming machine as recited in claim 1 wherein the ancillary display component operates when the gaming machine is in a tilt state.

18. A gaming system comprising:
a gaming machine having a cabinet, a master gaming controller configured to provide one or more games of chance, a primary game play monitor, a gaming machine network interface and at least one ancillary monitor component mechanically attached to the cabinet having an ancillary network interface and logic component;
a first host server coupled to provide for display on the primary game play monitor game play data to the master gaming controller the game play data transmitted over a first network utilizing the gaming machine network interface;
a second host server coupled to provide for display on the at least one ancillary monitor component non-game play data and secondary gaming data to the at least one ancillary monitor component, the data transmitted over a second network utilizing the ancillary network interface;
wherein the non-game play and secondary gaming data and the game play data are transmitted asynchronously via the secondary network and the first network respectively, thereby enabling viewing of the non-game play and secondary gaming data on the ancillary monitor component without interruption of game play on the primary game play monitor.

19. A gaming system as recited in claim 18 wherein the ancillary monitor component operates independently of the gaming machine.

20. A gaming system as recited in claim 18 wherein the logic processor of the ancillary monitor component operates outside the purview of gaming regulators.

21. A gaming system as recited in claim 18 wherein the first host server and the second host server communicate to share game play data and non-game play data, thereby enabling the at least one ancillary monitor component to display game play data.

22. A gaming system as recited in claim 18 wherein the ancillary monitor component has an RFID reader and an RFID antenna.

23. A gaming system as recited in claim 18 wherein the ancillary monitor component displays hospitality data location-specific data, hotel room data, hotel show data, and player purchase data.

24. A method of operating a gaming machine comprising:
detecting a player by using an RFID reader in an ancillary display component mechanically attached to a gaming machine cabinet;
identifying the player using RFID data;
obtaining non-gaming and secondary gaming data associated with the player;
displaying non-gaming and secondary gaming data to the player and interacting with the player by providing services to the player using the ancillary display component;
wherein position of the ancillary display component is adjustable and operates independently of the gaming machine.

25. A method as recited in claim 24 wherein displaying non-gaming and secondary gaming data further comprising utilizing a graphics controller in the ancillary display component.

26. A method as recited in claim 24 further comprising:
utilizing a display component logic processor to perform functions relating to the ancillary display component, wherein the logic processor is outside the purview of gaming regulatory entities.

27. A method as recited in claim 24 further comprising utilizing a master gaming controller to perform game play functions.

28. A method as recited in claim 24 wherein the player has an RFID tag.

29. A method as recited in claim 24 wherein displaying non-gaming and secondary gaming data to the player and interacting with the player occurs when the gaming machine is operational or non-operational.

30. A method as recited in claim 24 wherein obtaining non-gaming and secondary gaming data associated with the player further comprises accessing a non-gaming network separate from a primary gaming network used for game play.

31. A method as recited in claim 24 further comprising obtaining electrical power for ancillary display component from an external power source.

32. A method as recited in claim 24 wherein interacting with the player further comprises accessing a non-gaming server and a secondary gaming server.
